(19) United States
(12) Patent Application Publication
(10) Pub. No.: US 2026/0342157 A1
(43) Pub. Date: Oct. 29, 2026

(54) Outer-rotor brushless motor system for treadmill and the treadmill adopting the system

(71) Applicant: Elecway Technology Co., Ltd., Suzhou (CN)

(72) Inventors: Jianbo Wen, Suzhou (CN); Jiyou Liao, Suzhou (CN); Mingshan Cao, Suzhou (CN)

(21) Appl. No.: 19/657,881

(22) Filed: Apr. 24, 2026

(30) Foreign Application Priority Data
Apr. 27, 2025 (CN) 202510536948.7

(51) Int. Cl. H02K 1/2791; A63B 22/02; H02K 9/04

(52) U.S. Cl. CPC H02K 1/2791; A63B 22/0242; H02K 9/04; H02K 2201/03; H02K 2213/09

(57) ABSTRACT

The present invention relates to the technical field of brushless motors, and discloses an outer-rotor brushless motor system for a treadmill and the treadmill adopting the system, including a motor module, an induction sampling module and a cable module, wherein the motor module includes a rotor, magnets, a stator and a central shaft; the rotor is arranged around the outer periphery of the stator; the magnets are mounted at equal intervals on an inner wall of the rotor; the central shaft is arranged at the center of the stator; and the stator is energized by the cable module to generate an alternating magnetic field which cooperates with the magnets to drive the rotor to rotate continuously.

### CROSS-REFERENCE TO RELATED PATENT APPLICATION

This application claims the benefit of priority to China Patent Application No. 202510536948.7, filed on Apr. 27, 2025. The entire content of the above identified application is incorporated herein by reference.

### TECHNICAL FIELD

The present invention relates to the technical field of brushless motors, and more particularly, to an outer-rotor brushless motor system for a treadmill and the treadmill adopting the system.

### BACKGROUND ART

The motor of the treadmill is required to cope with different motion modes, such as walking, running, intermittent running and the like, and these modes require the motor to operate at different speeds and loads. To ensure smooth transition of these modes without accidental shutdown or insufficient power, precise speed and position feedback is required for the motor of the treadmill to improve control accuracy.

Sampling the rotation state of the motor by using an encoder and Hall induction has been maturely applied on treadmills, but traditional encoders have wear and maintenance problems due to the contact design with the motor shaft. Also, the Hall induction causes inaccurate sampling due to insufficient resolution accuracy, resulting in poor foot feel of the running belt during operation and poor experience of unsmooth start and stop, which limits its application in treadmill operation. Therefore, it is very necessary to provide an integrated system of a brushless motor and a high-speed induction module to realize non-contact induction sampling and improve durability and measurement recognition accuracy.

### SUMMARY OF THE INVENTION

The present invention provides an outer-rotor brushless motor system for a treadmill and the treadmill adopting the system, which solves the technical problems in the related art that traditional encoders have wear and maintenance problems due to the contact design with the motor shaft, and Hall induction causes inaccurate sampling due to insufficient resolution accuracy, resulting in poor foot feel of the running belt during operation and poor experience of unsmooth start and stop, thus limiting its application in treadmill operation.

The present invention provides an outer-rotor brushless motor system for a treadmill, including a motor module, an induction sampling module and a cable module, wherein the motor module includes a rotor, magnets, a stator and a central shaft; the rotor is arranged around the outer periphery of the stator; the magnets are mounted at equal intervals on an inner wall of the rotor; the central shaft is arranged at the center of the stator; the stator is energized by the cable module to generate an alternating magnetic field which cooperates with the magnets to drive the rotor to rotate continuously;
the induction sampling module aligned in parallel with the magnets is fixedly mounted at one end of the stator, so as to sample the rotation state of the magnets in a non-contact manner;
an air gap is arranged between the magnets and an outer edge of the stator; an adjustment module is arranged on the central shaft; and the adjustment module cooperates with the stator to pull the stator to extend and retract relative to the rotor so as to adjust the size of the air gap.

As a further scheme of the present invention, the adjustment module includes a shaft sleeve, an end cover, a rotating wheel, a bracket, a power source, a traction head and a hinge rope; a cavity for the central shaft to pass through is formed in the shaft sleeve; one side of the stator away from the induction sampling module is fixedly connected with the end cover; the rotating wheel is rotatably mounted on the shaft sleeve; the bracket is fixedly mounted on the shaft sleeve; the power source drives the traction head to slide on the bracket; one end of the hinge rope is fixed with the traction head and the other end is fixed with the end cover; and the rotating wheel is in contact with the hinge rope to provide steering limit.

As a further scheme of the present invention, the adjustment module further includes an air blowing assembly; the air blowing assembly includes a chuck, a rotating shaft, an air blowing head, a gear and a rack; the chuck is fixedly arranged on the shaft sleeve; the rotating shaft is rotatably arranged in the chuck; the air blowing head is fixedly mounted on the rotating shaft at the inner side of the chuck; the air blowing head outputs an air flow outward from the axis of the rotating shaft; the gear is fixedly mounted at an end of the rotating shaft; the rack cooperating with the gear is fixedly mounted on the end cover; and the rack moves synchronously when the end cover moves, driving the gear to rotate so as to make the air blowing head rotate.

As a further scheme of the present invention, a starting end of the rotation of the air blowing head is parallel to the central shaft, and a terminating end is perpendicular to the central shaft, with the rotation range being 0 degrees to 90 degrees; the rotation range of the air blowing head is divided into three continuous ranges; in the first range from 0 degrees to 30 degrees, the air flow output by the air blowing head corresponds to the stator; in the second range from 30 degrees to 60 degrees, the air flow output by the air blowing head corresponds to the inner wall of the rotor; and in the third range from 60 degrees to 90 degrees, the air flow output by the air blowing head deviates outward from the edge of the rotor to form an isolation air curtain.

As a further scheme of the present invention, a through groove is formed in a portion of the end cover corresponding to the air blowing head, so that the stator is exposed to correspond to the air flow output by the air blowing head As a further scheme of the present invention, the induction sampling module includes a silicon steel sheet, a sampling sensor and an interface; wherein the silicon steel sheet is fixedly mounted on the stator by bolts; the sampling sensor for collecting rotation information of the magnets is fixedly arranged on the silicon steel sheet; the interface is arranged on the silicon steel sheet; and the interface enables the sampling sensor to be electrically connected with the cable module, so as to output sampling data and supply power to the sampling sensor.

A treadmill adopting the above outer-rotor brushless motor system for the treadmill includes a power component and a treadmill body, wherein the power component is arranged in the treadmill body; the power component cooperates with an output end of the motor module; and the motor module is controlled to operate according to a sampling result of the induction sampling module so as to output power to the power component.

The invention has the following beneficial effects.

In the present invention, the induction sampling module does not directly contact the rotating outer rotor, but performs induction through changes of the magnetic field. The sensor generates electrical signals corresponding to the position, angle, speed and the like of the rotor by sensing changes of the magnetic field, without direct mechanical contact, thereby avoiding friction and wear and prolonging the service life of the system.

In the present invention, the adjustment module axially moves the stator to stagger with the rotor, which helps to adjust the air gap between the stator and the rotor, facilitates achieving a more uniform air gap distribution, reduces magnetic field asymmetry caused by non-uniform air gap, thereby balancing air gap changes caused by factors such as wear and thermal expansion during long-term operation of the motor, and further improving the efficiency and smoothness of the motor.

In the present invention, the sliding action of the adjustment module is used to drive the air blowing head to rotate. In the first range, the output air flow corresponds to the stator to provide heat dissipation and cooling effect for the stator. In the second range, the output air flow corresponds to the inner wall of the rotor to remove dust attached to the inner wall of the rotor. In the third range, the output air flow deviates outward from the edge of the rotor to form an isolation air curtain to prevent further entry of dust, thereby improving the phenomenon that dust is easily attached between the stator and the rotor due to the open layout of the outer-rotor motor.

### BRIEF DESCRIPTION OF THE DRAWINGS

FIG. 1 is a first overall structural schematic diagram of an outer-rotor brushless motor system for a treadmill proposed by the present invention;

FIG. 2 is a second overall structural schematic diagram of the outer-rotor brushless motor system for the treadmill proposed by the present invention;

FIG. 3 is an exploded structural schematic diagram of the outer-rotor brushless motor system for the treadmill proposed by the present invention;

FIG. 4 is a schematic diagram of a cooperation structure between a stator and an induction sampling module in the outer-rotor brushless motor system for the treadmill proposed by the present invention;

FIG. 5 is a structural schematic diagram of the induction sampling module in the outer-rotor brushless motor system for the treadmill proposed by the present invention;

FIG. 6 is a three-dimensional structural schematic diagram of an adjustment module in the outer-rotor brushless motor system for the treadmill proposed by the present invention;

FIG. 7 is an expanded structural schematic diagram of an air blowing assembly in the outer-rotor brushless motor system for the treadmill proposed by the present invention;

FIG. 8 is a schematic diagram of a rotation state of an air blowing head in the outer-rotor brushless motor system for the treadmill proposed by the present invention; and

FIG. 9 is a structural schematic diagram of the treadmill proposed by the present invention.

In the drawings, 1, motor module; 11, rotor; 12, magnet; 13, stator; 14, central shaft; 2, induction sampling module; 20, silicon steel sheet; 21, sampling sensor; 22, interface; 3, adjustment module; 31, shaft sleeve; 32, end cover; 33, rotating wheel; 34, bracket; 35, power source; 36, traction head; 37, hinge rope; 38, air blowing assembly; 381, chuck; 382, rotating shaft; 383, air blowing head; 384, gear; 385, rack; 4, cable module; 5, power component; 6, treadmill body.

### DETAILED DESCRIPTION

The subject matter described herein will now be discussed with reference to example embodiments. It should be understood that these embodiments are discussed only to enable those skilled in the art to better understand and thereby implement the subject matter described herein, and changes may be made in the function and arrangement of elements discussed without departing from the scope of protection of the present specification. Various processes or components may be omitted, substituted or added as required in various examples. In addition, features described with respect to some examples may be combined in other examples as well.

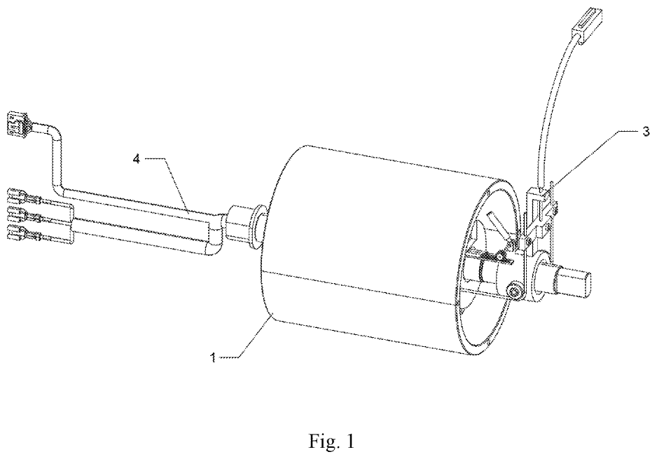

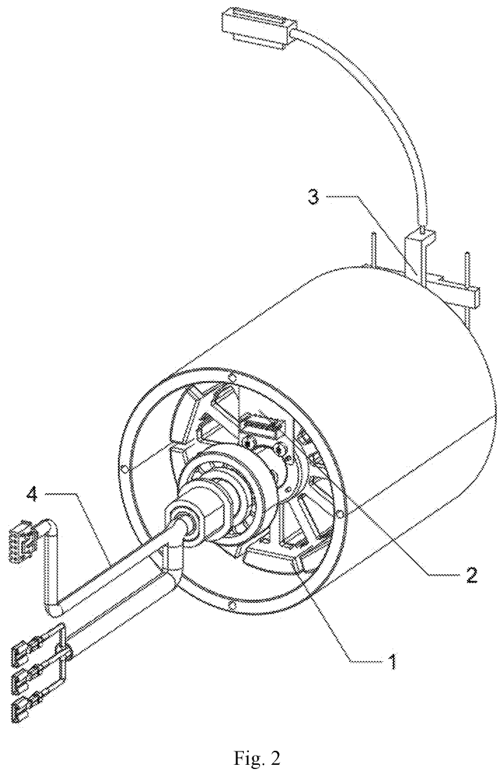

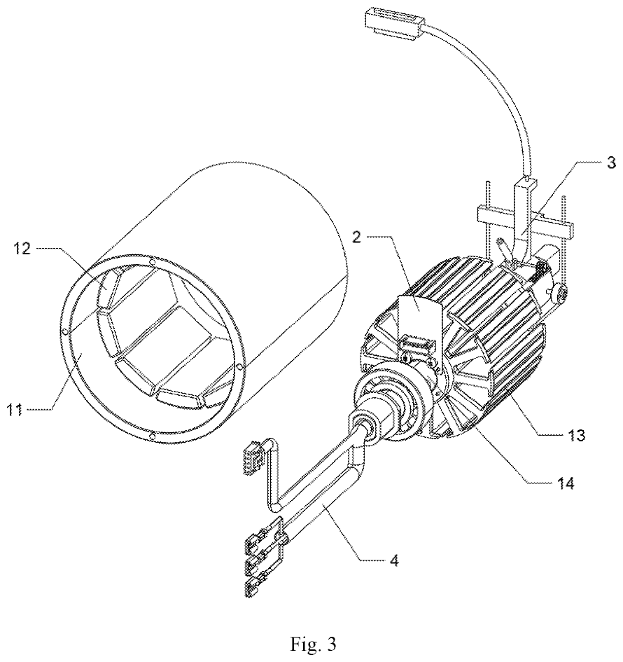

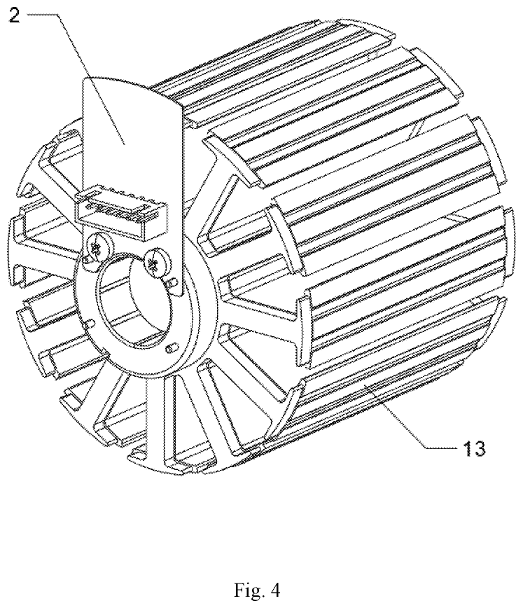

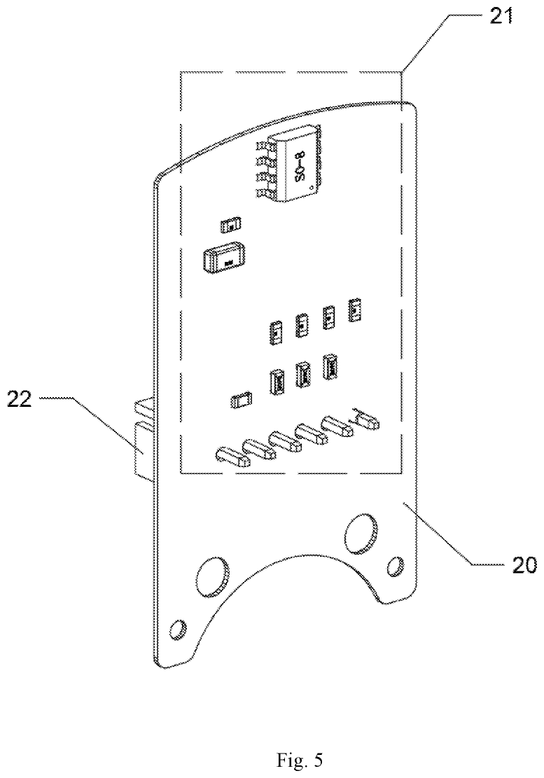

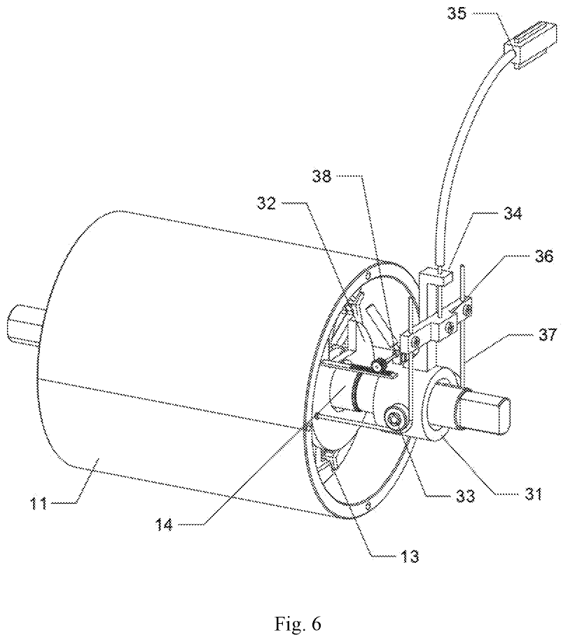

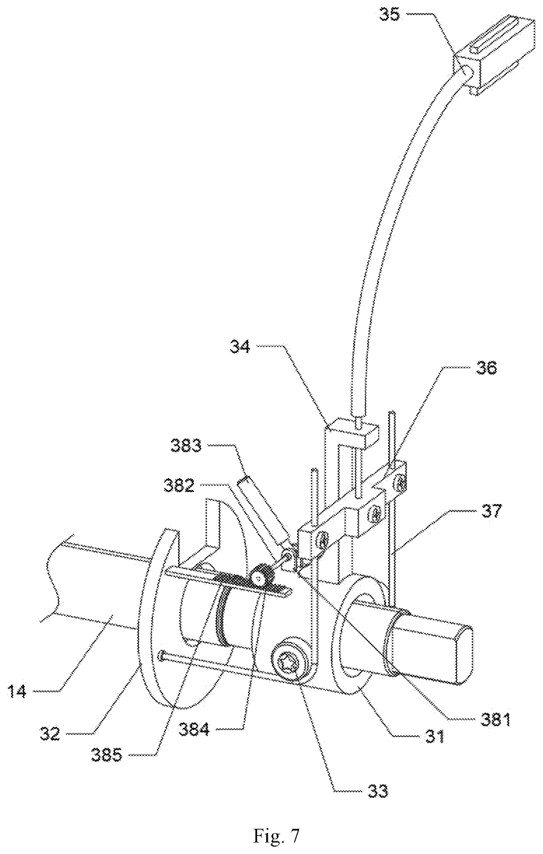

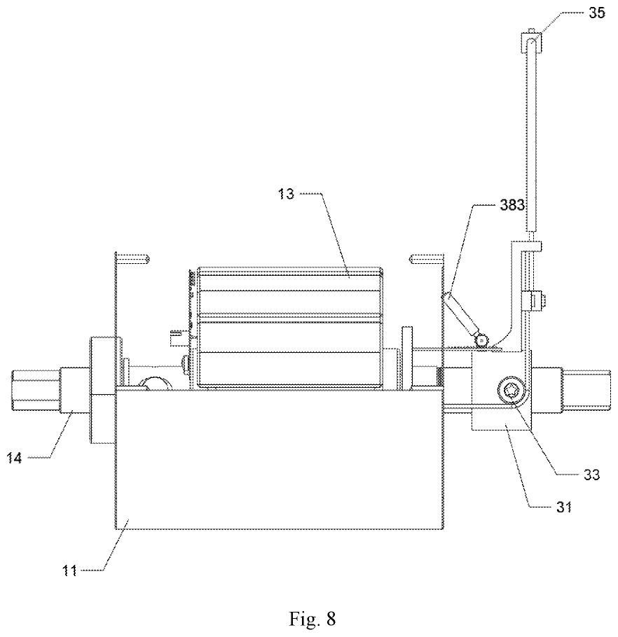

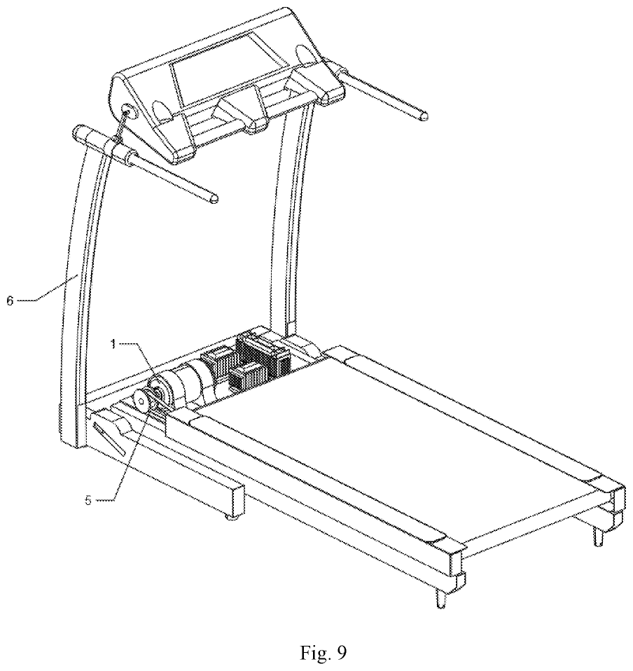

The present invention discloses an outer-rotor brushless motor system for a treadmill. As shown in FIGS. 1 to 9, the system includes a motor module 1, an induction sampling module 2 and a cable module 4, wherein the motor module 1 includes a rotor 11, magnets 12, a stator 13 and a central shaft 14; the rotor 11 is arranged around the outer periphery of the stator 13; the magnets 12 are mounted at equal intervals on an inner wall of the rotor 11; the central shaft 14 is arranged at the center of the stator 13; the stator 13 is energized by the cable module 4 to generate an alternating magnetic field which cooperates with the magnets 12 to drive the rotor 11 to rotate continuously;
the induction sampling module 2 aligned in parallel with the magnets 12 is fixedly mounted at one end of the stator 13, so as to sample the rotation state of the magnets 12 in a non-contact manner;
an air gap is arranged between the magnets 12 and an outer edge of the stator 13; an adjustment module 3 is arranged on the central shaft 14; and the adjustment module 3 cooperates with the stator 13 to pull the stator 13 to extend and retract relative to the rotor 11 so as to adjust the size of the air gap.

Axially moving the stator 13 to stagger with the rotor 11 helps to adjust the air gap between the stator 13 and the rotor 11, facilitates achieving a more uniform air gap distribution, reduces magnetic field asymmetry caused by non-uniform air gap, thereby improving the efficiency and smoothness of the motor.

It should be specially noted that in the form of the outer-rotor 11 motor, the rotation basis of the rotor 11 is generally a fixed structure such as a housing of the motor (not shown in the drawings), but this does not affect the realization of its rotation function.

The adjustment module 3 includes a shaft sleeve 31, an end cover 32, a rotating wheel 33, a bracket 34, a power source 35, a traction head 36 and a hinge rope 37; a cavity for the central shaft 14 to pass through is formed in the shaft sleeve 31; one side of the stator 13 away from the induction sampling module 2 is fixedly connected with the end cover 32; the rotating wheel 33 is rotatably mounted on the shaft sleeve 31; the bracket 34 is fixedly mounted on the shaft sleeve 31; the power source 35 drives the traction head 36 to slide on the bracket 34; one end of the hinge rope 37 is fixed with the traction head 36 and the other end is fixed with the end cover 32; and the rotating wheel 33 is in contact with the hinge rope 37 to provide steering limit.

In the adjustment module 3, the power source 35 drives the traction head 36 to slide on the bracket 34, thereby pulling the hinge rope 37 to retract and release. A structure similar to a brake is adopted to generate a stable traction force to one side of the end cover 32, and the structure has a position recoverable characteristic brake structure. Thus, when the air gap needs to be adjusted, only driving by the power source 35 is required, so as to balance air gap changes caused by factors such as wear and thermal expansion during long-term operation of the motor.

The adjustment module 3 further includes an air blowing assembly 38; the air blowing assembly 38 includes a chuck 381, a rotating shaft 382, an air blowing head 383, a gear 384 and a rack 385; the chuck 381 is fixedly arranged on the shaft sleeve 31; the rotating shaft 382 is rotatably arranged in the chuck 381; the air blowing head 383 is fixedly mounted on the rotating shaft 382 at the inner side of the chuck 381; the air blowing head 383 outputs an air flow outward from the axis of the rotating shaft 382; the gear 384 is fixedly mounted at an end of the rotating shaft 382; the rack 385 cooperating with the gear 384 is fixedly mounted on the end cover 32; and the rack 385 moves synchronously when the end cover 32 moves, driving the gear 384 to rotate so as to make the air blowing head 383 rotate. The outer rotor 11 motor is easy to cause dust to adhere between the stator 13 and the rotor 11 due to its open layout. To improve this phenomenon, the sliding action of the adjustment module 3 is used to drive the air blowing head 383 to rotate.

The starting end of the rotation of the air blowing head 383 is parallel to the central shaft 14, and a terminating end is perpendicular to the central shaft 14, with the rotation range being 0 degrees to 90 degrees; the rotation range of the air blowing head 383 is divided into three continuous ranges; in the first range from 0 degrees to 30 degrees, the air flow output by the air blowing head 383 corresponds to the stator 13; in the second range from 30 degrees to 60 degrees, the air flow output by the air blowing head 383 corresponds to the inner wall of the rotor 11; and in the third range from 60 degrees to 90 degrees, the air flow output by the air blowing head 383 deviates outward from the edge of the rotor 11 to form an isolation air curtain.

When the air blowing head 383 rotates in the first range, the output air flow corresponds to the stator 13 to provide heat dissipation and cooling effect for the stator 13; in the second range, the output air flow corresponds to the inner wall of the rotor 11 to remove dust attached to the inner wall of the rotor 11; and in the third range, the output air flow deviates outward from the edge of the rotor 11 to form an isolation air curtain to prevent further entry of dust.

A through groove is formed in a portion of the end cover 32 corresponding to the air blowing head 383, so that the stator 13 is exposed to correspond to the air flow output by the air blowing head 383.

The induction sampling module 2 includes a silicon steel sheet 20, a sampling sensor 21 and an interface 22; wherein the silicon steel sheet 20 is fixedly mounted on the stator 13 by bolts; the sampling sensor 21 for collecting rotation information of the magnets 12 is fixedly arranged on the silicon steel sheet 20; the interface 22 is arranged on the silicon steel sheet 20; and the interface 22 enables the sampling sensor 21 to be electrically connected with the cable module 4, so as to output sampling data and supply power to the sampling sensor 21.

A treadmill adopting the above outer-rotor brushless motor system for the treadmill includes a power component 5 and a treadmill body 6, wherein the power component 5 is arranged in the treadmill body 6; the power component 5 cooperates with an output end of the motor module 1; and the motor module 1 is controlled to operate according to a sampling result of the induction sampling module 2 so as to output power to the power component 5.

The embodiments of the present invention have been described above, but the embodiments are not limited to the above specific implementations. The above specific implementations are illustrative rather than restrictive. Those of ordinary skill in the art can make many equivalent embodiments within the scope of the embodiments under the enlightenment of the embodiments, all of which fall within the protection scope of the embodiments.

1. An outer-rotor brushless motor system for a treadmill, comprising: a motor module (1), an induction sampling module (2) and a cable module (4), wherein the motor module (1) comprises a rotor (11), magnets (12), a stator (13) and a central shaft (14);
the rotor (11) is arranged around the outer periphery of the stator (13); the magnets (12) are mounted at equal intervals on an inner wall of the rotor (11); the central shaft (14) is arranged at the center of the stator (13); the stator (13) is energized by the cable module (4) to generate an alternating magnetic field which cooperates with the magnets (12) to drive the rotor (11) to rotate continuously;
the induction sampling module (2) aligned in parallel with the magnets (12) is fixedly mounted at one end of the stator (13), so as to sample the rotation state of the magnets (12) in a non-contact manner;
an air gap is arranged between the magnets (12) and an outer edge of the stator (13); an adjustment module (3) is arranged on the central shaft (14); and the adjustment module (3) cooperates with the stator (13) to pull the stator (13) to extend and retract relative to the rotor (11) so as to adjust the size of the air gap.

2. The outer-rotor brushless motor system for a treadmill of claim 1, wherein the adjustment module (3) comprises a shaft sleeve (31), an end cover (32), a rotating wheel (33), a bracket a power source (35), a traction head (36) and a hinge rope (37); a cavity for the central shaft (14) to pass through is formed in the shaft sleeve (31); one side of the stator (13) away from the induction sampling module (2) is fixedly connected with the end cover (32);
the rotating wheel (33) is rotatably mounted on the shaft sleeve (31); the bracket (34) is fixedly mounted on the shaft sleeve (31); the power source

(35) drives the traction head (36) to slide on the bracket (34); one end of the hinge rope (37) is fixed with the traction head (36) and the other end is fixed with the end cover (32); and the rotating wheel (33) is in contact with the hinge rope (37) to provide steering limit.

3. The outer-rotor brushless motor system for a treadmill of claim 2, wherein the adjustment module (3) further comprises an air blowing assembly (38); the air blowing assembly (38) comprises a chuck (381), a rotating shaft (382), an air blowing head (383), a gear (384) and a rack (385); the chuck (381) is fixedly arranged on the shaft sleeve (31); the rotating shaft (382) is rotatably arranged in the chuck (381); the air blowing head (383) is fixedly mounted on the rotating shaft (382) at the inner side of the chuck (381); the air blowing head (383) outputs an air flow outward from the axis of the rotating shaft (382); the gear (384) is fixedly mounted at an end of the rotating shaft (382); the rack (385) cooperating with the gear (384) is fixedly mounted on the end cover (32); and the rack (385) moves synchronously when the end cover (32) moves, driving the gear (384) to rotate so as to make the air blowing head (383) rotate.

4. The outer-rotor brushless motor system for a treadmill of claim 3, wherein a starting end of the rotation of the air blowing head (383) is parallel to the central shaft (14), and a terminating end is perpendicular to the central shaft

(14) with the rotation range being 0 degrees to 90 degrees; the rotation range of the air blowing head (383) is divided into three continuous ranges;
in the first range from 0 degrees to 30 degrees, the air flow output by the air blowing head (383) corresponds to the stator (13); in the second range from 30 degrees to 60 degrees, the air flow output by the air blowing head (383) corresponds to the inner wall of the rotor (11); and in the third range from 60 degrees to 90 degrees, the air flow output by the air blowing head (383) deviates outward from the edge of the rotor (11) to form an isolation air curtain.

5. The outer-rotor brushless motor system for a treadmill of claim 4, wherein a through groove is formed in a portion of the end cover (32) corresponding to the air blowing head (383), so that the stator (13) is exposed to correspond to the air flow output by the air blowing head (383).

6. The outer-rotor brushless motor system for a treadmill of claim 5, wherein the induction sampling module (2) comprises a silicon steel sheet (20), a sampling sensor (21) and an interface (22); wherein the silicon steel sheet (20) is fixedly mounted on the stator (13) by bolts; the sampling sensor (21) for collecting rotation information of the magnets (12) is fixedly arranged on the silicon steel sheet (20); the interface (22) is arranged on the silicon steel sheet (20); and the interface (22) enables the sampling sensor (21) to be electrically connected with the cable module (4), so as to output sampling data and supply power to the sampling sensor (21).

7. A treadmill adopting the system of claim 1, comprising: a power component (5) and a treadmill body (6), wherein the power component (5) is arranged in the treadmill body (6); the power component (5) cooperates with an output end of the motor module (1); and the motor module (1) is controlled to operate according to a sampling result of the induction sampling module (2) so as to output power to the power component (5).

8. A treadmill adopting the system of claim 2, comprising: a power component (5) and a treadmill body (6), wherein the power component (5) is arranged in the treadmill body (6); the power component (5) cooperates with an output end of the motor module (1); and the motor module (1) is controlled to operate according to a sampling result of the induction sampling module (2) so as to output power to the power component (5).

9. A treadmill adopting the system of claim 3, comprising: a power component (5) and a treadmill body (6), wherein the power component (5) is arranged in the treadmill body (6); the power component (5) cooperates with an output end of the motor module (1); and the motor module (1) is controlled to operate according to a sampling result of the induction sampling module (2) so as to output power to the power component (5).

10. A treadmill adopting the system of claim 4, comprising: a power component (5) and a treadmill body (6), wherein the power component (5) is arranged in the treadmill body (6); the power component (5) cooperates with an output end of the motor module (1); and the motor module (1) is controlled to operate according to a sampling result of the induction sampling module (2) so as to output power to the power component (5).

11. A treadmill adopting the system of claim 5, comprising: a power component (5) and a treadmill body (6), wherein the power component (5) is arranged in the treadmill body (6); the power component (5) cooperates with an output end of the motor module (1); and the motor module (1) is controlled to operate according to a sampling result of the induction sampling module (2) so as to output power to the power component (5).

12. A treadmill adopting the system of claim 6, comprising: a power component (5) and a treadmill body (6), wherein the power component (5) is arranged in the treadmill body (6); the power component (5) cooperates with an output end of the motor module (1); and the motor module (1) is controlled to operate according to a sampling result of the induction sampling module (2) so as to output power to the power component (5).
